(19) United States
(12) Patent Application Publication
(10) Pub. No.: US 2015/0316193 A1
(43) Pub. Date: Nov. 5, 2015

(54) Test-plug-plate

(71) Applicant: Paul Joseph Reinbold, Portland, ME (US)

(72) Inventor: Paul Joseph Reinbold, Portland, ME (US)

(21) Appl. No.: 14/120,203

(22) Filed: May 5, 2014

(51) Int. Cl. F16L 55/11

(52) U.S. Cl. CPC F16L 55/11

(57) ABSTRACT

A Test-Plug-Plate is a plate designed to be inserted into a mounting plate or installation bracket used for protecting and testing of residential and commercial central vacuum cleaning systems during the “rough-in” stage of construction. The purpose of the invention is to provide central vacuum cleaning system installers a way to check for vacuum leakage, voltage, and circuit continuity throughout the entire installed system in both residential and commercial central vacuum cleaning systems prior to the insulation and drywall installed during construction. The double air-tight sealing feature, the construction debris protection feature, and the ease of electrical voltage and continuity testing makes this invention a very effective cover plate and testing tool for the central vacuum cleaning industry.

### DISCUSSION OF PRIOR ART

Prior art is replete with descriptions of methods and adaptations for testing residential and commercial central vacuum cleaning systems during the “rough-in” stage of construction where testing is most important.

With respect to U.S. Pat. No. 4,338,764 a Closure Inserting Method the Field of the Invention states: it's use in self-sealing closures for tubular vacuum holding containers, for cannula penetrable containers, and containers needed to be gas-proof. The Summary of the Invention states that the closure member has flexible, elastic sidewalls, is self-sealing, and can be pierced with a needle. None of these features or methods indicate any appropriate application to home and commercial central vacuum cleaning systems.

With respect to U.S. Pat. No. 5,735,425 a Reusable beer keg plug the abstract states: that this plug is formed of an elastomeric material, is expandable, used in Beer Kegs, and expands by a tightening device forming part of the plug. None of these features coincide with the Test-Plug-Plate further described in this application.

With respect to U.S. Pat. No. 6,494,463 a Plug for sealing more than one size of hole the abstract states: that this plug has a hollow body surrounded by at least three flexible sealing ribs, that it can be used for different size holes, and that a screw driver may be necessary for insertion into a hole. This plug might have slight application, but will not aide in construction debris protection of the entire receiving mounting plate or installation bracket, will most likely destroy the “0” ring upon insertion into the receiving mounting plate or installation bracket that needs to be intact for the completion phase of construction, and lastly will offer no protection for voltage wiring.

With respect to U.S. Pat. No. 3,358,869 a Vacuum sealing plug—the abstract states: that this plug is resilient, has a diaphragm, is inserted within a tubular member, and made reference to HVAC and refrigeration applications. The Test-Plug-Plate is a solid device which does not need to expand or contract, does not have a diaphragm for any reason, and is not inserted within tubing required for a central vacuum cleaning system. The Test-Plug-Plate is specifically designed to interface with a receiving mounting plate or installation bracket.

With respect to U.S. Pat. No. 5,944,057 a Bore plug and bore plugging method the abstract states: that the invention relates to a bore plug and plugging method and has a particular application for sealing and isolating defective heat exchanger tubes. Claim 1 of this patent states it is made of two parts: a sealing member with an axial opening that can receive the holding member. The Test-Plug-Plate is a solid device which does not need to expand or contract, nor does it have any holding member that will act to expand the plug to fit some orifice.

With respect to U.S. Pat. No. 6,459,056 a Cleaning apparatus for central vacuum system the Detailed Description of Preferred Embodiments as shown in FIG. 25 states that: “Positioned in the cylindrical opening (292) of the bracket is an O-ring seal (304) which seals the joint between the bracket and the rearwardly extending pipe section of the inlet apparatus.” Reference is made to these typical “O-ring” embodiments in current mounting plates and installation brackets to which an interface is made with the Test-Plug-Plate (A) in the following: FIG. 2, FIG. 3, Summary of Invention, and Claim 1.

### BACKGROUND OF INVENTION

In the home construction process there are several phases operating simultaneously across most all the construction trades: plumbing, electrical, HVAC, central vacuum, security systems, etc. Shortly after a home has been framed, roofed, and shingled—subcontractors are scheduled to perform what is known in the trades as the “rough-in” on this newly constructed dwelling.

Towards the end of the rough-in, plumbers, using pressure gauges, are able to fill their piping and pressure test all their connections. This testing procedure is extremely important before the drywall is installed. In the same venue, electricians are able to test the continuity of all their wiring and connections prior to the drywall installation.

Having worked for a couple central vacuum companies, over the past 20+ years, I have never seen any installer perform a vacuum test or voltage continuity test on a residential or commercial central vacuum cleaning system during the rough-in phase. Like the plumber, this testing procedure is extremely important before the drywall is installed.

on This Test-Plug-Plate (A) is designed to address the vacuum and electrical testing procedures that should be performed on every central vacuum cleaning system installation before the drywall goes on the walls.

### SUMMARY OF INVENTION

To address the importance of vacuum system testing during the rough-in phase of home construction, the Test-Plug-Plate (A) was invented to assist installers, of central vacuum cleaning systems, to be able to test their roughed-in mounting plate with it's connected tubing system for vacuum leaks, poorly glued fittings, and continuity of voltage carrying wire before the drywall is installed.

The Test-Plug-Plate (A) can be modified and adapted to any style mounting plate or installation bracket. Mounting plates and installation brackets, for residential and commercial applications, are fastened to structural framing members during construction and are designed to hold a rubber “O” ring which slightly protrudes the cylindrical wall of this receiving member as shown in (FIG. 3). When the Test-Plug-Plate is inserted into the mounting plate or installation bracket an interface is formed between the long flange (16) of the Test-Plug-Plate and the rubber “O” ring of the mounting plate or installation bracket creating the first of two air-tight seals.

Unique to the Test-Plug-Plate is the additional rubber “O” ring located on the stop flange (17). There is always a chance that the “O” ring, of the receiving member mounting plate or installation bracket, was damaged, misaligned, or twisted during fabrication. The “O” ring applied to the Test-Plug-Plate stop flange creates the second air-tight seal between the Test-Plug-Plate and mounting plates and installation brackets. This interface is a naturally effective seal due to the Atmospheric Pressure of approximately 14.7 PSI +/−. With a plate surface covering the flanges circular area, at full vacuum, a pressure of +/−29 pounds is exerted compressing the Test-Plug-Plate to the mounting plate and or installation bracket. If additional pressure is needed fastening screws could always be tightened further. This second air-tight seal assures a more accurate vacuum measurement and leak detection.

This Test-Plug-Plate (A) is designed to encompass three different, but related applications all at the same time. First, as with other cover plates, this Test-Plug-Plate will protect the system's wiring and the mounting plate or installation bracket, with it's incorporated rubber “O-ring” (FIG. 3 prior art), from paint, dust, mudding, and construction debris. Secondly, unlike other cover plates, this Test-Plug-Plate will form two air- tight seals so that a vacuum test on the entire “roughed-In” system can be performed before the drywall goes on the walls. Lastly, unlike other cover plates, this Test-Plug-Plate will allow the installer to test the electrical continuity at each valve location in the “roughed-in” system simultaneously as the vacuum is being tested at that location.

Another notable characteristic of the Test-Plug-Plate is that it is easily removed and reused multiple times without damaging ether of the two “O” rings described in this presentation. Other than removal of the fastening screws, there are no tools necessary to insert or remove any Test-Plug-Plate from any mounting plate or installation bracket making this invention a more effective cover plate and testing tool for the central vacuum industry.

### DESCRIPTION OF THE DRAWINGS

FIG. 1.

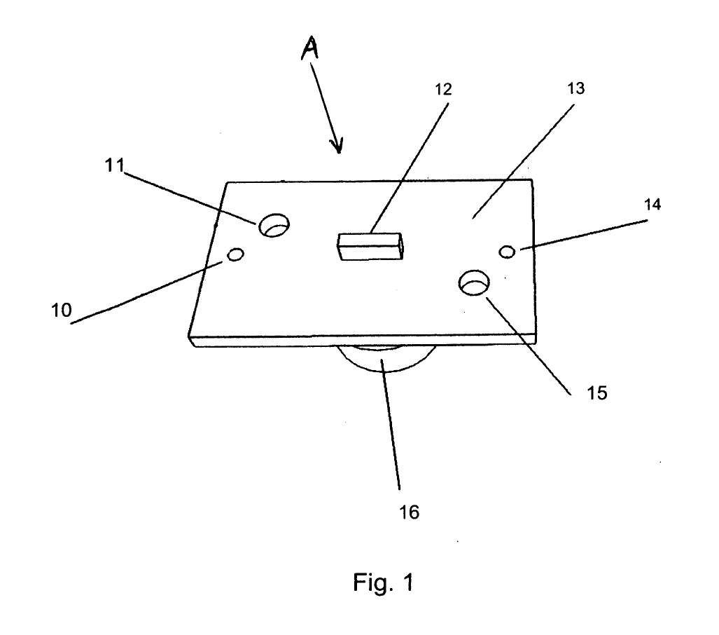

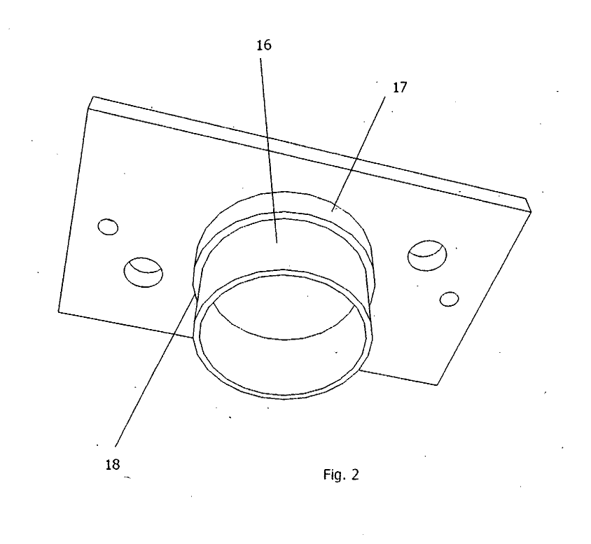

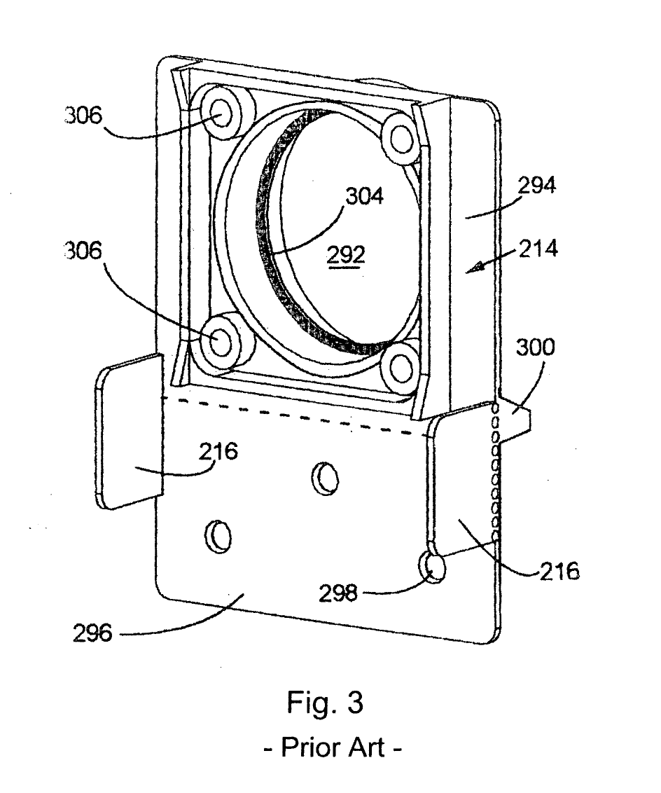

The top face of the rectangular Test-Plug-Plate (A) is designed with four holes and a tab means (12) centered and perpendicular to the face plate (13). The two smaller holes (10, 14) accommodate two fastening screws that will hold the Test-Plug-Plate to the mounting plate or installation bracket, in a secure position, during the testing procedure. The two larger holes (11, 15) accommodate the low voltage wiring to extend through the Test-Plug-Plate to assist in a voltage and continuity testing procedure. The Test-Plug-Plate can be rotated 180 degrees via tab means (12) with all the holes in the correct alignment with the mounting plate or installation bracket. The Test-Plug-Plate can be rotated in a 90° arc via tab means (12) to allow for different orientation of the plate for testing higher voltage of electrical circuitry installed in residential and commercial central vacuum cleaning systems and electrical continuity of the electrical circuits.

FIG. 2.

On the underside of Test-Plug-Plate (A) there is a long cylindrical extrusion flange (16) designed to extend into an opening on the receiving mounting plate or installation bracket, and extend beyond a rubber “O-ring” incorporated into the mounting plate or installation bracket and thus creating an air-tight seal for vacuum testing. There is a larger diameter stop flange (17) at the bottom of the long flange to hold a second “O” ring (18). This stop flange and “O” ring combination will control the depth at which the Test-Plug-Plate extends into the mounting plate or installation bracket . This rubber “O” ring will slide over the longer flange, rests on the larger stop flange, and will form another interface air-tight seal between the Test-Plug-Plate and the mounting plate or installation bracket.

FIG. 3 (prior art).

Reference is made to typical “O-ring” embodiments in current mounting plates and installation brackets to which an interface is made between the Test-Plug-Plate and such an O-ring. With respect to U.S. Pat. No. 6,459,056 a Cleaning apparatus for central vacuum system FIG. 25, prior art, shows the position of an O-ring seal (304) positioned in the cylindrical orifice opening (292) of a mounting plate or installation bracket which makes a seal with an inlet apparatus. Representative and applicable of the “inlet apparatus” is this Test-Plug-Plate referenced in FIG. 2, Summary of Invention, and claim 1.

1. A Test-Plug-Plate (A) for testing vacuum integrity of residential and commercial central vacuum cleaning system installations including:
a plate (13) with a long flange (16) which creates a first air-tight seal interface between the plate's long flange (16) and a rubber “O” ring (302) which is part of a mounting plate or installation bracket (FIG. 3 prior art) used in residential and commercial central vacuum system installations; said plate (13) with a circular rubber “O” ring (18) positioned on the long flange and located on a stop flange (17) which is mounted adjacent to the long flange which creates a second air-tight seal interface between the plate's rubber “O” ring and an opening of the mounting plate or installation bracket used in residential and commercial central vacuum system installations (FIG. 3 prior art); said plate (13) creating two air-tight seals with respect to the circular orifice (292) of said mounting plate or installation bracket used in residential and commercial central vacuum system installations (FIG. 3 prior art).

2. A Test-Plug-Plate (A), for insertion and attachment to a mounting plate or installation bracket for installation in residential and commercial central vacuum cleaning system , for testing wiring integrity of voltage and electrical continuity of circuitry to be installed the residential and commercial central vacuum cleaning system installations including:
a face plate (13) including a flat planar surface with holes (11, 15) allowing for the extraction and retraction of terminal electrical circuitry installed in residential and commercial central vacuum cleaning systems;
said plate's flat planar surface having holes (11, 15) for low voltage testing and continuity of electrical circuitry installed in residential and commercial central vacuum cleaning systems; said plate's flat planar surface having tab means (12) for manual rotation of the plate in a 90° arc to allow for different orientation of the plate to allow for higher voltage testing of electrical circuitry installed in residential and commercial central vacuum cleaning systems and electrical continuity of the electrical circuits.

3. A Test-Plug-Plate (A) as claimed in claim 1, further including:
a face plate (13) including a flat planar surface protecting and shielding the mounting plate or installation bracket of the central vacuum system from paint, dust, plastering, and construction debris;
said plate's stop flange (17) with it's “O” ring (18) protecting and shielding the mounting plate or installation bracket opening of the central vacuum system from paint, dust, plastering, and construction debris; said face plate (13) with a flat planar surface protecting and shielding the terminal electrical circuitry from paint, dust, plastering, and construction debris in residential and commercial central vacuum cleaning systems.

4. The Test-Plug-Plate (A) for cooperating with a housing comprising:
a face plate (13) including a flat planar surface with holes (10,11) for attachment to the housing;
said face flat planar surface having holes (14,15) for electrical testing of wiring in the housing;
said flat planar surface of face plate (13) with tab means (12) for rotating the plate allowing for different plate orientations on the housing;
said face plate (13) including an underside flat planar surface with a long flange (16);
said underside flat planar surface having a stop flange (17);
said underside flat planar surface having a long flange (16) holding a rubber “O” ring (18).
